(19) United States
(12) Patent Application Publication
(10) Pub. No.: US 2006/0261880 A1
(43) Pub. Date: Nov. 23, 2006

(54) Charge pump type booster circuit and antenna switch

(75) Inventors: Kenichi Hidaka, Osaka (JP); Tadayoshi Nakatsuka, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/434,055

(22) Filed: May 16, 2006

(30) Foreign Application Priority Data
May 17, 2005 (JP) 2005-143954

(51) Int. Cl. G05F 1/10

(52) U.S. Cl. 327/536

(57) ABSTRACT

An output voltage Vout from a boost processing section 20 is divided by resistances 41 and 42, and a resultant divided output voltage Va is input to one of two input terminals of a comparator 45. A reference voltage Vb obtained by dividing a voltage Vcc by resistances 43 and 44 is input to the other input terminal of the comparator 45. The comparator 45 compares the divided output voltage Va with the reference voltage Vb, and when the divided output voltage Va is lower, outputs a HIGH voltage, and when the divided output voltage Va is higher, outputs a LOW voltage. Thereby, an signal oscillating section 10 performs oscillation at a radio frequency (an N-type CMOS FET 18 is in the OFF state) when the output voltage Vout does not exceed a threshold value determined by the reference voltage Vb, and performs oscillation at a low frequency (the N-type CMOS FET 18 is in the ON state) when the output voltage Vout exceeds the threshold value.

### BACKGROUND OF THE INVENTION

1. Field of the Invention

The present invention relates to a charge pump type booster circuit, and an antenna switch using the same.

2. Description of the Background Art

An exemplary configuration of a conventional charge pump type booster circuit 100 is illustrated in FIG. 7. The conventional booster circuit 100 of FIG. 7 comprises a signal oscillating section 110 composed of a NAND 111, a resistance 112, inverters 114 and 115, and a capacitance 116, and a boost processing section 120 composed of diodes 121 to 124, capacitances 125 to 127, and inverters 128 to 132.

A voltage Vcc corresponding to a power supply voltage is applied to one of two input terminals of the NAND 111. The output terminal of the NAND 111 is feedback-connected via the resistance 112, the capacitance 116, the inverter 114, and the inverter 115 to the other input terminal of the NAND 111. With this configuration, the signal oscillating section 110 performs oscillation having an oscillation frequency f which is determined based on the resistance 112 and the capacitance 116.

The diodes 121 to 124 are connected in series. The voltage Vcc is input to the anode terminal of the first-stage diode 121. One of two terminals of each of the capacitances 125 to 127 is connected to a connection point between the corresponding anode and cathode terminals. The other terminal of each of the capacitances 125 to 127 receives an oscillation signal output from the signal oscillating section 110 via a corresponding predetermined number of ones of the inverters 128 to 132. With this configuration, in the boost processing section 120, the capacitances 125 to 127 connected in the form of a plurality of stages via the diodes 121 to 124 alternately repeatedly perform changing and discharging to successively transfer electric charge from the voltage Vcc, thereby making it possible to boost the voltage Vcc to a predetermined voltage, which is in turn output.

For example, Japanese Patent Laid-Open Publication No. 11-55156 discloses a antenna switch for switching ON/OFF a radio frequency signal which employs the conventional charge pump type booster circuit 100.

In the conventional charge pump type booster circuit 100, a boosted voltage is obtained by storing electric charge into the capacitances 125 to 127 and transferring the electric charge. Therefore, immediately after the start of the boosting operation, the voltage gradually increases, and it takes a long time to obtain a desired voltage. In other words, the conventional charge pump type booster circuit 100 has a long rise time. In order to reduce the rise time of the charge pump type booster circuit 100, it is considered to increase the number of times of charging and discharging of the capacitances 125 to 127 by increasing the oscillation frequency of the signal oscillating section 110.

In this method, although the rise time immediately after applying the power supply voltage can be effectively reduced, the booster circuit continues to be oscillated at a radio frequency after reaching the desired voltage, so that a power supply current increases as compared to a booster circuit having a low oscillation frequency. Therefore, a booster circuit which employs this method disadvantageously has large power consumption.

### SUMMARY OF THE INVENTION

Therefore, an object of the present invention is to provide a charge pump type booster circuit capable of performing a rapid boost until a predetermined potential, and after reaching the predetermined potential, reducing power consumption.

The present invention is directed to a charge pump type booster circuit, and an antenna switch which employs the booster circuit. To achieve the above-described object, the booster circuit of the present invention comprises a signal oscillating section, a boost processing section, and an oscillation control section. In the antenna switch, the booster circuit of the present invention is used as a power supply circuit for supplying power to a logic circuit which performs an operation of switching ON/OFF a radio frequency signal.

The signal oscillating section outputs an oscillation signal having a frequency determined based on a time constant of a capacitance and a resistance. The boost processing section boosts an input voltage by alternately repeatedly performing charging and discharging of the input voltage in accordance with the oscillation signal output from the signal oscillating section using a plurality of diodes and a plurality of capacitances, to transfer electric charge. The oscillation control section compares a voltage boosted and output by the boost processing section with a predetermined reference voltage, and based on a result of the comparison, changes the time constant of the signal oscillating section to control the frequency of the oscillation signal.

The oscillation control section may control the frequency by changing the capacitance value of the time constant which determines the frequency of the oscillation signal. Alternatively, the oscillation control section may control the frequency by changing the resistance value of the time constant which determines the frequency of the oscillation signal.

The oscillation control section may change a level of the reference voltage or a level of the voltage which is compared by the reference voltage, depending on the level of the voltage boosted and output by the boost processing section.

According to the present invention, the frequency of the oscillation signal is caused to be high by controlling the capacitance value or the resistance value of the time constant until the boosted voltage reaches a predetermined potential. After the boosted voltage reaches the predetermined potential, the frequency of the oscillation signal is controlled to be low. Thereby, a rapid boost can be performed until the predetermined potential, and after reaching the predetermined potential, power consumption can be reduced.

In addition, by controlling a divided output voltage (Va) and/or a reference voltage (Vb) of a comparator, the frequency of the oscillation signal is controlled to be kept high for a predetermined time after the boosted voltage reaches a predetermined potential, and after the predetermined time has elapsed, the frequency of the oscillation signal is controlled to be lowered. Thereby, the rise time can be reduced.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating a configuration of a charge pump type booster circuit 1 according to a first embodiment of the present invention;

FIG. 2 is a diagram illustrating a relationship between an output voltage of a boost processing section 20, a control voltage of an oscillation control section 40, and an oscillation frequency of a signal oscillating section 10;

FIG. 3 is a diagram illustrating a configuration of a charge pump type booster circuit 2 according to a second embodiment of the present invention;

FIG. 4 is a diagram illustrating a configuration of a charge pump type booster circuit 3 according to a third embodiment of the present invention;

FIG. 5 is a diagram illustrating a configuration of a charge pump type booster circuit 4 according to a fourth embodiment of the present invention;

FIG. 6 is a diagram illustrating an exemplary antenna switch 5 which comprises any one of the booster circuits 1 to 4 of the first to fourth embodiment of the present invention; and

FIG. 7 is a diagram illustrating an exemplary configuration of a conventional booster circuit 100.

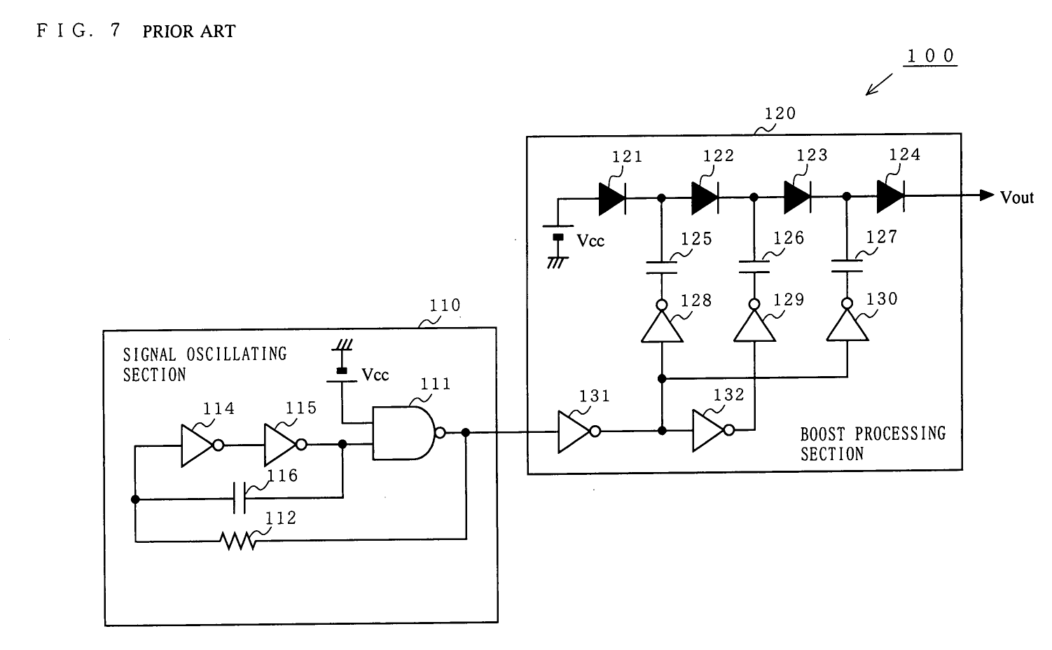

### DESCRIPTION OF THE PREFERRED EMBODIMENTS

### First Embodiment

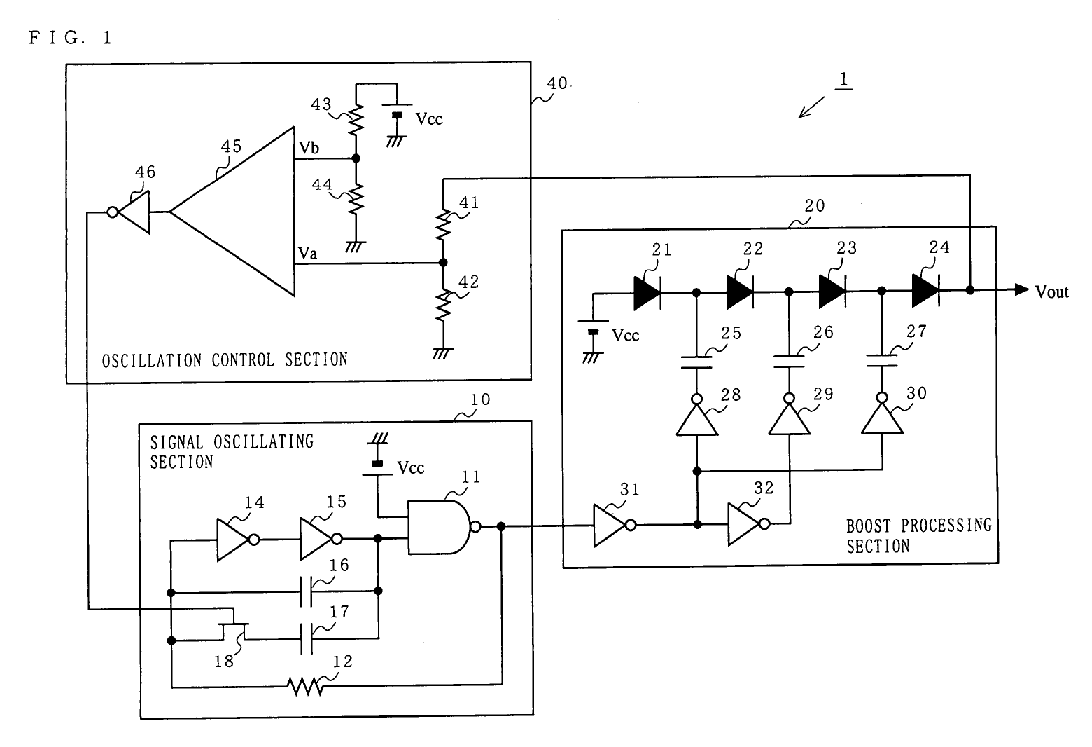

FIG. 1 is a diagram illustrating a configuration of a charge pump type booster circuit 1 according to a first embodiment of the present invention. In FIG. 1, the booster circuit 1 of the first embodiment comprises a signal oscillating section 10, a boost processing section 20, and an oscillation control section 40.

The signal oscillating section 10 is composed of a NAND 11, a resistance 12, inverters 14 and 15, capacitances 16 and 17, and an N-type CMOS FET 18. A voltage Vcc corresponding to a power supply voltage is applied to one of two input terminals of the NAND 11. The output terminal of the NAND 11 is feedback-connected via the resistance 12, the inverters 14 and 15, and the capacitances 16 and/or 17 to the other input terminal of the NAND 11. The N-type CMOS FET 18 is inserted between the resistance 12 and the capacitance 17, and functions as a switching element. With this configuration, the signal oscillating section 10 performs oscillation at a predetermined frequency. In this case, the oscillation frequency f is determined based on the resistance 12 and the capacitances 16 and 17 as follows.

The N-type CMOS FET 18 is switched ON/OFF in accordance with an instruction from the oscillation control section 40 described below. When the N-type CMOS FET 18 is in the OFF state, the capacitance 17 is not connected, so that the signal oscillating section 10 has an oscillation frequency f_{OFF} which is determined based on a time constant which is obtained based on the resistance 12 and the capacitance 16. On the other hand, when the N-type CMOS FET 18 is in the ON state, the capacitance 17 is connected, so that the signal oscillating section 10 has an oscillation frequency f_{ON} which is determined based on a time constant which is obtained based on the resistance 12, and a large capacitance value of the capacitances 16 and 17 connected in parallel. Therefore, when the N-type CMOS FET 18 is in the ON state, the oscillation frequency is lower (i.e., f_{OFF}>f_{ON}).

The boost processing section 20 is composed of diodes 21 to 24, capacitances 25 to 27, and inverters 28 to 32. The diodes 21 to 24 are connected in series. A voltage Vcc is input to the anode terminal of the first-stage diode 21. One of two terminals of each of the capacitances 25 to 27 is connected to a connection point between the corresponding anode and cathode terminals. The other terminal of each of the capacitances 25 to 27 receives an oscillation signal output from the signal oscillating section 10 via a corresponding predetermined number of ones of the inverters 28 to 32. Note that the number of the inverters 28 to 32 is set so that charging and discharging of the capacitances 25 to 27 due to the oscillation signal are alternately performed in order of connection. In the example of FIG. 1, a period of time during which charging of the capacitances 25 and 27 and discharging of the capacitance 26 are performed, and a period of time during which discharging of the capacitances 25 and 27 and charging of the capacitance 26 are performed, are alternately repeated. With this configuration, in the boost processing section 20, electric charge is successively and repeatedly transferred via the diodes 21 to 24, so that the voltage Vcc input to the anode terminal of the first-stage diode 21 is boosted and output via the cathode terminal of the final-stage diode 24.

The oscillation control section 40 is composed of resistances 41 to 44, a comparator 45, and an inverter 46. An output voltage Vout which is boosted and output by the boost processing section 20 is divided by the resistances 41 and 42, and a resultant divided output voltage Va is input to one of two input terminals of the comparator 45. A reference voltage Vb obtained by dividing the voltage Vcc by the resistances 43 and 44 is input to the other input terminal of the comparator 45. The comparator 45 compares the divided output voltage Va with the reference voltage Vb, and when the divided output voltage Va is lower, outputs a HIGH voltage, and when the divided output voltage Va is higher, outputs a LOW voltage. The inverter 46 reverses the polarity of a voltage output from the comparator 45, and outputs a resultant voltage as a control voltage Vcont to the gate terminal of the N-type CMOS FET 18 of the signal oscillating section 10. Specifically, when the output voltage Vout of the boost processing section 20 does not exceed a threshold value which is determined based on the reference voltage Vb of the oscillation control section 40, the output (the control voltage Vcont) of the oscillation control section 40 is the LOW voltage, and when the output voltage Vout of the boost processing section 20 exceeds the threshold value, the output of the oscillation control section 40 is the HIGH voltage. Note that the HIGH voltage refers to a voltage which causes the N-type CMOS FET 18 to be in the ON state when it is input to the gate of the N-type CMOS FET 18.

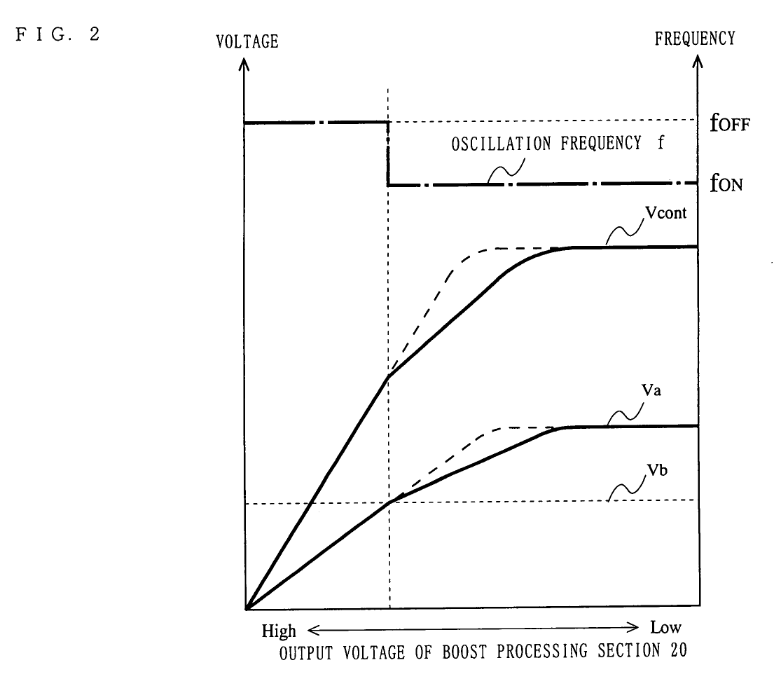

According to the above-described configuration and operation, during the time when the output voltage Vout of the boost processing section 20 does not exceed the threshold value which is determined based on the reference voltage Vb of the oscillation control section 40, the N-type CMOS FET 18 is in the OFF state, so that the signal oscillating section 10 performs oscillation at the radio frequency f_{OFF}. When the output voltage Vout of the boost processing section 20 exceeds the threshold value, the N-type CMOS FET 18 goes to the ON state, so that the signal oscillating section 10 performs oscillation at the low frequency f_{ON}. FIG. 2 illustrates a relationship between the output voltage Vout of the boost processing section 20, the control voltage Vcont of the oscillation control section 40, and the oscillation frequency f of the signal oscillating section 10.

As described above, according to the charge pump type booster circuit 1 of the first embodiment of the present invention, the frequency of the oscillation signal is caused to be high by controlling the capacitance value of the time constant until the boosted voltage reaches a predetermined potential. After the boosted voltage reaches the predetermined potential, the frequency of the oscillation signal is controlled to be low. Thereby, a rapid boost can be performed until the predetermined potential, and after reaching the predetermined potential, power consumption can be reduced.

### Second Embodiment

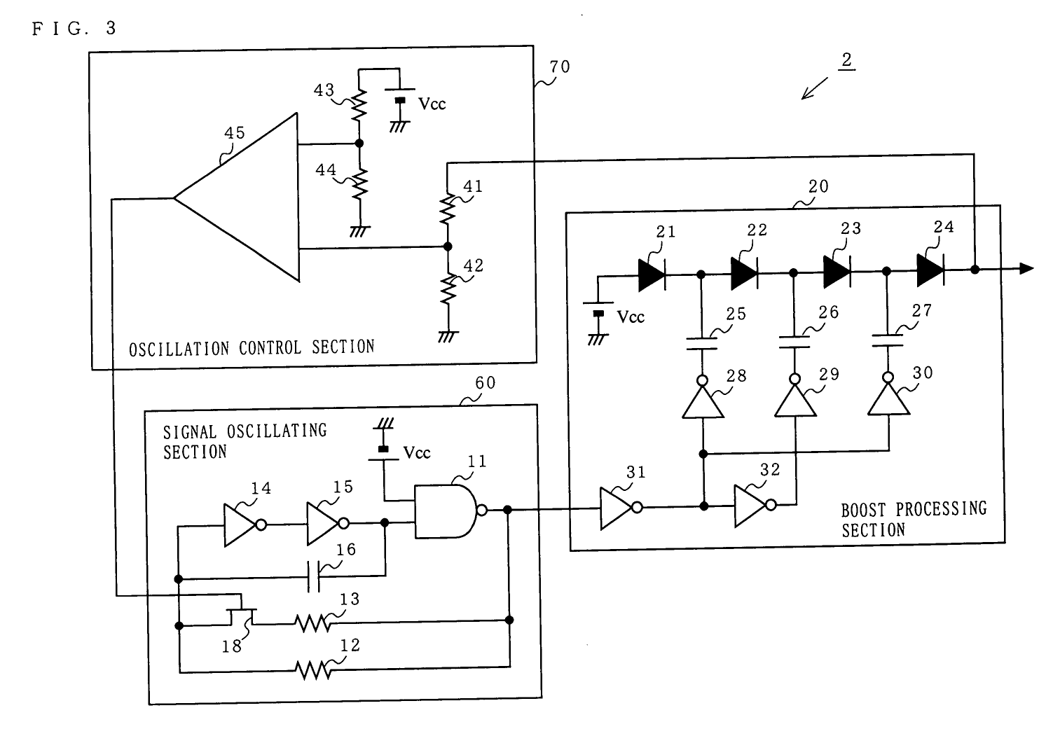

FIG. 3 is a diagram illustrating a configuration of a charge pump type booster circuit 2 according to a second embodiment of the present invention. In FIG. 3, a booster circuit 2 of the second embodiment comprises a signal oscillating section 60, a boost processing section 20, and an oscillation control section 70.

The signal oscillating section 60 is composed of a NAND 11, resistances 12 and 13, inverters 14 and 15, a capacitance 16, and an N-type CMOS FET 18. The oscillation control section 70 is composed of resistances 41 to 44, and a comparator 45. As can be seen from FIG. 3, the booster circuit 2 of the second embodiment has the same configuration as that of the booster circuit 1 of the first embodiment, except that the capacitance 17 is replaced with the resistance 13, and the inverter 46 is removed, and they have basically the same operation. The signal oscillating section 60 having such a configuration has an oscillation frequency f which is determined based on the resistance 12, the resistance 13, and the capacitance 16 as follows.

The comparator 45 of the oscillation control section 70 compares the divided output voltage Va with the reference voltage Vb, and when the divided output voltage Va is lower, outputs a HIGH voltage, and when the divided output voltage Va is higher, outputs a LOW voltage. The N-type CMOS FET 18 is switched ON/OFF in accordance with an instruction from the comparator 45. When the N-type CMOS FET 18 is in the ON state, the resistance 13 is connected, so that an oscillation frequency f_{ON} of the signal oscillating section 60 is determined based on a time constant which is obtained based on a small resistance value of the resistances 12 and 13 connected in parallel, and the capacitance 16. On the other hand, when the N-type CMOS FET 18 is in the OFF state, the resistance 13 is not connected, so that an oscillation frequency f_{OFF} of the signal oscillating section 60 is determined based on a time constant which is obtained based on the resistance 12 and the capacitance 16. Therefore, when the N-type CMOS FET 18 is in the OFF state, the oscillation frequency is lower (i.e., f_{OFF}<f_{ON}).

As described above, according to the charge pump type booster circuit 2 of the second embodiment of the present invention, the frequency of the oscillation signal is caused to be high by controlling the resistance value of the time constant until the boosted voltage reaches a predetermined potential. After the boosted voltage reaches the predetermined potential, the frequency of the oscillation signal is controlled to be low. Thereby, a rapid boost can be performed until the predetermined potential, and after reaching the predetermined potential, power consumption can be reduced.

### Third Embodiment

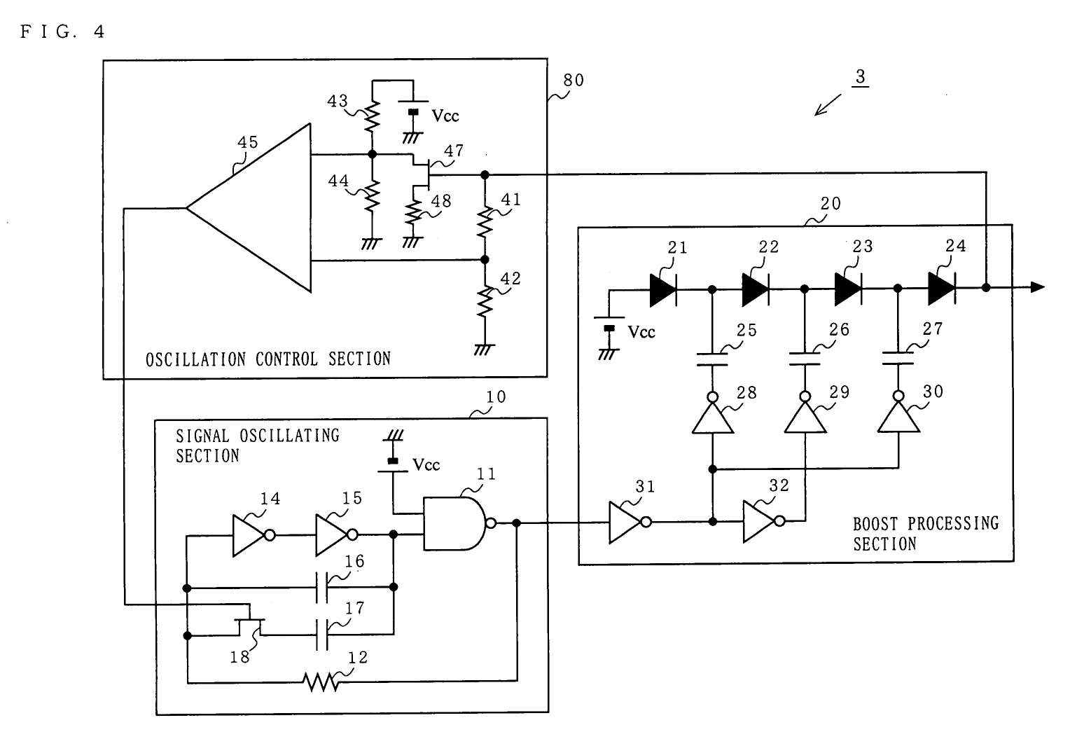

FIG. 4 is a diagram illustrating a charge pump type booster circuit 3 according to a third embodiment of the present invention. In FIG. 4, the booster circuit 3 of the third embodiment comprises a signal oscillating section 10, a boost processing section 20, and an oscillation control section 80.

The oscillation control section 80 is composed of resistances 41 to 44 and 48, a comparator 45, and an N-type CMOS FET 47. As can be seen from FIG. 4, the booster circuit 3 of the third embodiment has the same configuration as that of the booster circuit 1 of the first embodiment, except that the N-type CMOS FET 47 and the resistance 48 are added into the oscillation control section 40 of the booster circuit 1 of the first embodiment. The oscillation control section 80 having such a configuration changes the reference voltage Vb which is compared with the divided output voltage Va, depending on a level of the output voltage Vout which is boosted and output by the boost processing section 20.

The reference voltage Vb is changed, depending on whether or not the level of the output voltage Vout is a voltage which causes the N-type CMOS FET 47 to go to the ON state. Specifically, when the N-type CMOS FET 47 is in the OFF state, the resistance 48 is not connected, so that the reference voltage Vb is a voltage divided by the resistances 43 and 44. On the other hand, when the N-type CMOS FET 47 is in the ON state, the resistance 48 is connected, so that the reference voltage Vb is a voltage which is divided by the resistance 43 and a small resistance value of the resistances 44 and 48 connected in parallel.

As described above, according to the charge pump type booster circuit 3 of the third embodiment of the present invention, by controlling the reference voltage Vb of the comparator 45, the frequency of the oscillation signal is controlled to be kept high for a predetermined time after the boosted voltage reaches a predetermined potential, and after the predetermined time has elapsed, the frequency of the oscillation signal is controlled to be lowered. Thereby, the rise time can be reduced as compared to the first and second embodiments.

### Fourth Embodiment

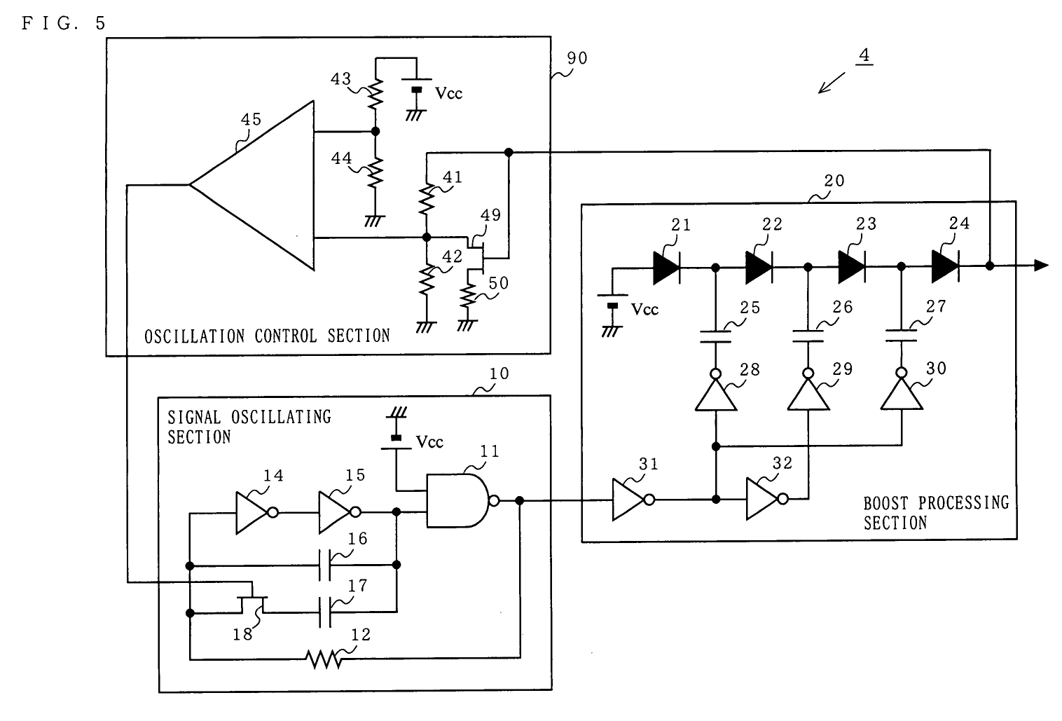

FIG. 5 is a charge pump type booster circuit 4 according to a fourth embodiment of the present invention. In FIG. 5, the booster circuit 4 of the fourth embodiment comprises a signal oscillating section 10, a boost processing section 20, and an oscillation control section 90.

The oscillation control section 90 is composed of resistances 41 to 44, and 50, a comparator 45, and an N-type CMOS FET 49. As can be seen from FIG. 5, the booster circuit 4 of the fourth embodiment has the same configuration as that of the booster circuit 1 of the first embodiment, except that the N-type CMOS FET 49 and the resistance 50 are added into the oscillation control section 40 of the booster circuit 1 of the first embodiment The oscillation control section 90 having such a configuration changes the divided output voltage Va which is compared with the reference voltage Vb, depending on a level of the output voltage Vout which is boosted and output by the boost processing section 20.

The divided output voltage Va is changed, depending on whether or not the level of the output voltage Vout is a voltage which causes the N-type CMOS FET 49 to go to the ON state. Specifically, when the N-type CMOS FET 49 is in the OFF state, the resistance 50 is not connected, so that the divided output voltage Va is a voltage divided by the resistances 41 and 42. On the other hand, when the N-type CMOS FET 49 is in the ON state, the resistance 50 is connected, so that the divided output voltage Va is a voltage which is divided by the resistance 41 and a small resistance value of the resistances 42 and 50 connected in parallel.

As described above, according to the charge pump type booster circuit 4 of the fourth embodiment of the present invention, by controlling the divided output voltage Va of the comparator 45, the frequency of the oscillation signal is controlled to be kept high for a predetermined time after the boosted voltage reaches a predetermined potential, and after the predetermined time has elapsed, the frequency of the oscillation signal is controlled to be lowered. Thereby, the rise time can be reduced as compared to the first and second embodiments.

Note that the booster circuits 1 to 4 described in the first to fourth embodiments are provided only for illustrative purposes, and the present invention is not limited to these circuit configurations. The signal oscillating sections 10 and 60 are not limited to the particular configurations as long as the oscillation frequency can be changed by an external control. The oscillation control sections 40, 70, 80, and 90 are not limited to the particular configurations as long as the divided output voltage Va and/or the reference voltage Vb can be changed by an external control.

The additional configuration which is described regarding the oscillation control section 80 in the third embodiment and the additional configuration which is described regarding the oscillation control section 90 in the fourth embodiment may be employed in combination.

### Example of Antenna Switch

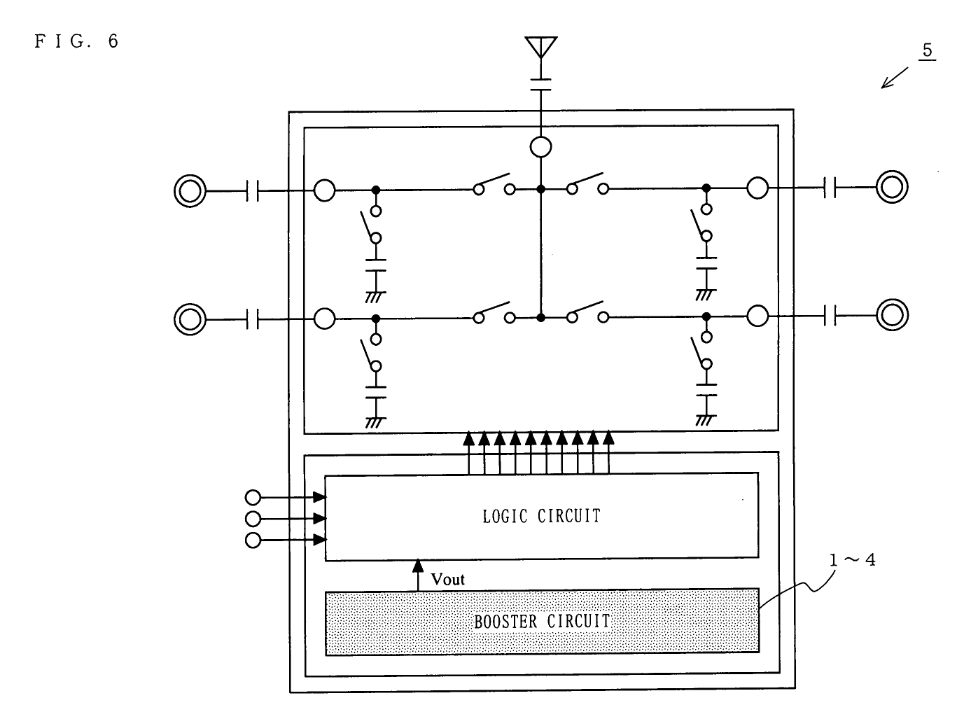

FIG. 6 is a diagram illustrating an exemplary antenna switch 5 which comprises the booster circuit of the present invention and switches ON/OFF a radio frequency signal in accordance with an operation of a logic circuit. The antenna switch 5 comprises any one of the booster circuits 1 to 4 of the present invention as a power supply circuit which supplies power to a logic circuit. By employing the booster circuit of the present invention as a power supply circuit, the radio frequency signal can be switched ON/OFF while establishing both a short rise time and low power consumption.

While the invention has been described in detail, the foregoing description is in all aspects illustrative and not restrictive. It is understood that numerous other modifications and variations can be devised without departing from the scope of the invention.

What is claimed is:

1. A charge pump type booster circuit comprising:
a signal oscillating section operable to output an oscillation signal having a frequency determined based on a time constant of a capacitance and a resistance;
a boost processing section operable to boost an input voltage by alternately repeatedly performing charging and discharging of the input voltage to transfer electric charge in accordance with the oscillation signal output from the signal oscillating section using a plurality of diodes and a plurality of capacitances; and
an oscillation control section operable to compare a voltage boosted and output by the boost processing section with a predetermined reference voltage, and based on a result of the comparison, to change the time constant of the signal oscillating section to control the frequency of the oscillation signal.

2. The charge pump type booster circuit according to claim 1, wherein the oscillation control section controls the frequency by changing the capacitance value of the time constant which determines the frequency of the oscillation signal.

3. The charge pump type booster circuit according to claim 1, wherein the oscillation control section controls the frequency by changing the resistance value of the time constant which determines the frequency of the oscillation signal.

4. The charge pump type booster circuit according to claim 1, wherein the oscillation control section can change a level of the reference voltage, depending on a level of the voltage boosted and output by the boost processing section.

5. The charge pump type booster circuit according to claim 1, wherein the oscillation control section can change a level of the voltage which is boosted and output by the boost processing section and is compared by the reference voltage, depending on the level of the voltage boosted and output by the boost processing section.

6. An antenna switch operable to switch ON/OFF a radio frequency signal in accordance with an operation of a logic circuit, wherein the booster circuit according to any one of claims 1 to 5 is used as a power supply circuit for supplying a power to the logic circuit.
